(19) United States
(12) Patent Application Publication
(10) Pub. No.: US 2005/0095396 A1
(43) Pub. Date: May 5, 2005

(54) Paper handling aid

(76) Inventor: Patricia M. Reo, Toms River, NJ (US)

Correspondence Address: MICHAEL R. PHILIPS, 5 TURNBERRY CIRCLE, P.O. BOX 1818, TOMS RIVER, NJ, 08754-1818, US

(21) Appl. No.: 10/699,964

(22) Filed: Nov. 3, 2003

(51) Int. Cl. B32B 7/00

(52) U.S. Cl. 428/120; 428/143; 428/343

(57) ABSTRACT

A paper handling aid in the form of a flexible high friction membran is shown with an adhesive coating on one side for temporarily attaching the aid to the pad portion of a finger. As used, the paper handling aid provides a degree of friction against the paper to improve paper handling. In a first embodiment of the invention, the paper handling aid is formed with an array of protuberances on the non-adhesive surface to enhance handling paper corners. In another embodiment, the non-adhesive surface is smooth, utilizing the frictional characteristics of the membrane material for paper handling. The aid may be of various shapes, for example, round, rectangular or hexagonal, and is supplied on a medium with a release backing.

### FIELD OF THE INVENTION

The present invention relates to the field of manual devices to improve the manual handling, sorting, or separating of sheets of paper, and more particularly to such a device that is releasably adhered to a finger of the user.

### BACKGROUND OF THE INVENTION

The task of handling, sorting or separating sheets of paper by hand depends upon the degree of friction between the paper and the fingers of the user. Insufficient friction impedes the user from easily moving or lifting the corners of the paper sheets to perform the needed task. Performing paper handling tasks efficiently generally requires a coefficient of friction greater than that which naturally exists.

A somewhat common way for an individual to correct the lack of sufficient friction is to moisten his or her paper-handling finger tip with saliva. This procedure may be unsanitary and, for many people, not polite. A more sanitary and acceptable means to correct this low friction problem is to place a molded finger tip cover over the end of the finger. Molded finger tip covers have been commercially available for a long time. Known molded finger tip covers are typically made of a high-friction synthetic or natural material and are formed with a pattern of protuberances on the outer surface thereof. However, these molded finger tip covers have the drawback that the cavity into which one places one's finger is fixed in size, thus, one size does not fit all, being loose for some and constrictive for others. A second drawback is that the molded finger tip cover, even if it is properly sized, when worn for some time tends to be uncomfortable and often sweaty. A third drawback is that the molded finger tip cover is not adaptable if the user has finger nails that extend beyond the tip of the finger.

Therefore, a paper handling aid is needed for increasing the friction between the user's finger and the paper being handled which fits all finger sizes, does not interfere with extended length fingernails and is not uncomfortable or hot to the finger when worn. The present invention provides such a paper handling aid which is also economical and convenient to use.

### SUMMARY OF THE INVENTION

The present invention provides a paper handling aid in the form of a small, flexible, high friction membrane that has an adhesive coating on one side for being affixed on the pad portion of a user's finger. In use, the paper handling aid establishes a coefficient of friction when pressed against the paper that is great enough to enable efficient paper handling. In a first embodiment of the invention, the aid is formed with an array of protuberances on the non-adhesive surface to improve handling and the separating of paper edges. In another embodiment, the non-adhesive surface is smooth, relying fully on the frictional characteristics of the material for paper handling. The paper handling aid may be formed in various shapes, for example, round, rectangular or hexagonal, and is supplied on a sheet having a release backing.

### BRIEF DESCRIPTION OF THE DRAWINGS

The present invention is best understood when read in conjunction with the accompanying drawing figures in which like elements are identified by similar reference numerals and wherein:

FIG. 1 is a plan view of a first embodiment of the paper handling aid of the present invention.

FIG. 1A is a plan view of a second embodiment of the paper handling aid of the present invention.

FIG. 2 is a cross sectional view of the first embodiment of the paper handling aid of FIG. 1 taken in the direction of line 2-2 thereof.

FIG. 2A is a cross sectional view of the second embodiment of the paper handling aid of FIG. 1A taken in the direction of line 2A-2A thereof.

FIG. 3 is an elevation view of a hand of a user with the paper handling aid of the present invention adhered to a finger thereof.

FIG. 4 is a plan view of a series of paper handling aids of the second embodiment as mounted on a release backing sheet.

FIG. 5 is a plan view of a modified shape of the present invention.

### DETAILED DESCRIPTION OF THE PREFERRED EMBODIMENTS

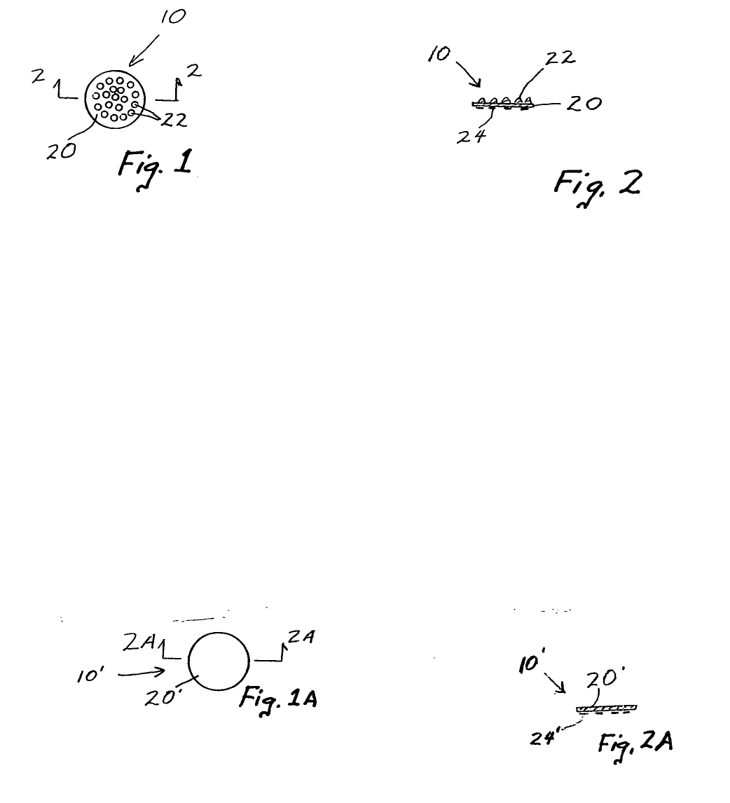

As generally described above, a paper handling aid 10 is illustrated in FIGS. 1 and 2 according to the first preferred embodiment of the invention. Paper handling aid 10 comprises a substantially planar base membrane 20 having an array of protuberances 22 formed on a first surface thereof. Protuberances 22 are substantially equal in height as measured from the first surface of membrane 20. The height of protuberances 22 is left to the discretion of the designer and is, for example, 0.6 mm (0.025 inches). Protuberances 22 further assist the user in separating and lifting the edges of paper sheets being sorted or otherwise handled. Base membrane 20 and protuberances 22 are formed, for example, by injection molding or casting, from a flexible, elastomeric material characterized by a relatively high coefficient of friction against paper. The coefficient of friction against paper is preferably in the range of from 0.50-0.90, and more preferably approximately 0.85. Examples of elastomeric materials of which the paper handling aid of the invention may be formed are latex rubber and polyurethane resin. A coating of an adhesive 24 is applied to a second surface of base membrane 20, opposed to the first surface on which protuberances 22 are formed. Adhesive layer 24 is illustrated by dashed lines for reasons of clarity. The applied adhesive 24 is formulated so as to adhere substantially permanently to base membrane 20 and to adhere releasably to the skin of a user. In particular, when paper handling aid 10 is removed from the skin, no residue of adhesive 24 remains on the skin. Preferably, adhesive 24 is hypo-allergenic so as not to cause irritation of the skin which it contacts. Adhesive 24 is also formulated to be capabl of multipi uses, that is, pap r handling aid 10 may be applied to and removed from the skin of the user multiple times.

Referring now to FIGS. 1A and 2A, a second embodiment of the invention paper handling aid 10′ is illustrated in plan and in cross section. This second embodiment of the invention paper handling aid 10′ is formed with a base membrane 20′ having an adhesive coating 24′ applied on a first surface. The opposed second surface of this second embodiment is substantially smooth, i.e. lacking protuberances, and relies on the high frictional characteristic of the membrane 20′ material to enable its paper handling and sorting tasks.

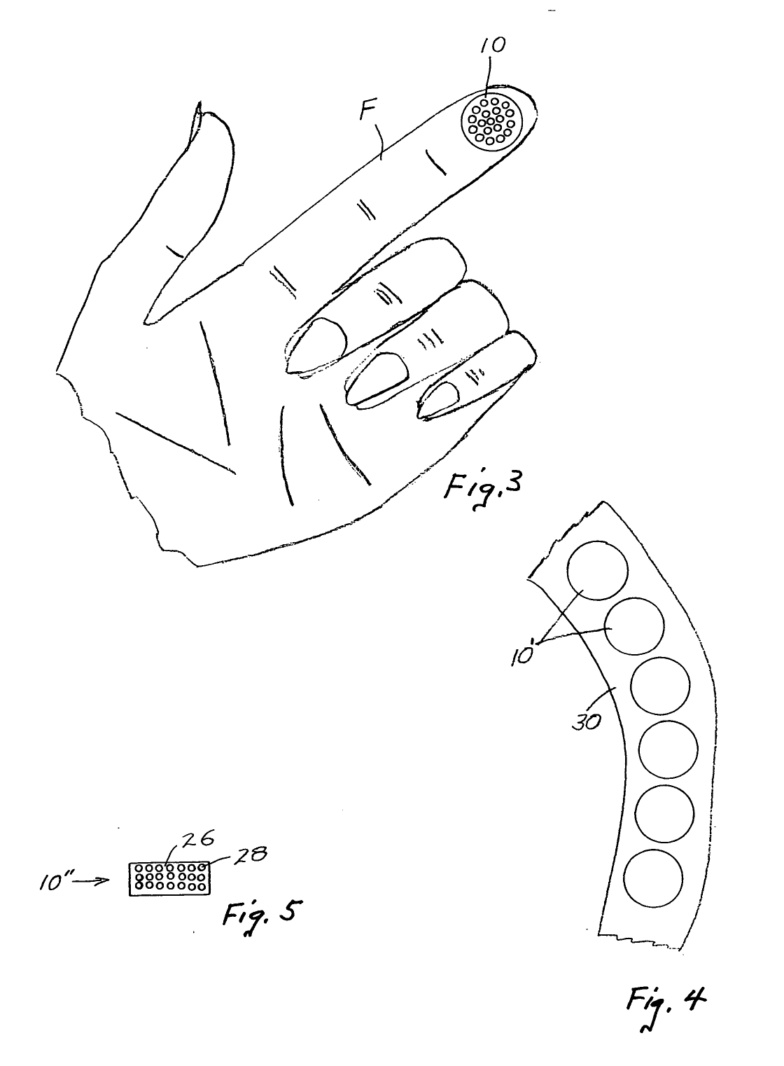

Referring now to FIG. 3, a specimen of paper handling aid 10 according to the first embodiment of the invention is shown applied adhesively to the pad portion of the left index finger F of a user with adhesive 24 in contact with the users skin. The term “pad portion” of the finger refers to the soft tissue portion that is opposed to the fingernail. Paper handling aid 10 is flexible so as to conform to the shape of the user's finger. As will be apparent, while the task for which paper handling aid 10 is intended involves handling, sorting or separating sheets of paper, the user is able to contemporaneously perform related tasks, e.g. computer typing, hand writing, calculating, etc., without interference from applied paper handling aid 10. It is within the scope of the invention to apply paper handling aid 10 to any finger of the user, according to the individual's preference and the task being performed. For example, it is believed to be somewhat more convenient to apply paper handling aid 10 to the fourth finger (ring finger) if the user is writing with a pen or pencil during the task of paper handling. Paper handling aid 10 has been found not to interfere when the secondary task involves typing or use of a calculator. It is to be noted that paper handling aid 10 does not enclose the tip of finger F, so as to prevent significant heat build-up or constriction and discomfort that often occurs when using the finger tip covers of the prior art. In addition, paper handling aid 10 of the invention does not interfere with extended length fingernails of the user, if present.

Referring now to FIG. 4, a linear array of paper handling aids 10′ (according to the second preferred embodiment of the invention) is illustrated as mounted on a release backing delivery medium 30, for example as provided in a retail sales package. Delivery medium 30 may be a linear strip, as shown, a rectangular sheet, or any other convenient shape.

Referring now to FIG. 5, a modified shape of paper handling aid 10″ is shown in comparison to the configuration of the first preferred embodiment. The modified shape in FIG. 5 is rectangular, but other modified shapes, for example elliptical, hexagonal, square, etc., are contemplated. In addition, such modified shapes are possible with either first or second embodiments of the invention, as described above.

While the description above discloses preferred embodiments and modified shapes of the present invention, it is contemplated that numerous additional variations and modifications of the invention are possible and are considered to be within the scope of the claims that follow.

1. A paper handling aid, comprising:
a. a substantially planar membrane formed of a flexible, frictional material and sized to fit on the pad portion of a finger; and
b. an adhesive coating on a first surface of the membrane;
c. wherein in use the adhesive is in contact with the pad portion of the finger.

2. The paper handling aid as described in claim 1, further comprising a plurality of protuberances formed on a second surface of the membrane.

3. The paper handling aid as described in claim 1, wherein the membrane material is elastomeric.

4. The paper handling aid as described in claim 1, wherein the adhesive adheres substantially permanently to the first surface of the membrane and adheres releasably to the pad portion of the finger.

5. The paper handling aid as described in claim 1, wherein the adhesive is hypo-allergenic.

6. The paper handling aid as described in claim 4, wherein the adhesive is hypo-allergenic.

7. The paper handling aid as described in claim 1, wherein the membrane material has a sufficiently high coefficient of friction to improve the task of handling, sorting and separating paper.

8. The paper handling aid as described in claim 1, wherein the membrane material has a coefficient of friction against paper in the range of 0.50-0.90.

9. The paper handling aid as described in claim 8, wherein the coefficient of friction is greater than 0.80.

10. The paper handling aid as described in claim 1, wherein the paper handling aid is substantially round when viewed in plan.

11. The paper handling aid as described in claim 1, wherein the paper handling aid is non-round when viewed in plan.

12. The paper handling aid as described in claim 2, wherein the membrane material has a sufficiently high coefficient of friction to improve the task of handling, sorting and separating paper.

13. The paper handling aid as described in claim 2, wherein the membrane material has a coefficient of friction against paper in the range of 0.50-0.90.

14. The paper handling aid as described in claim 13, wherein the coefficient of friction is greater than 0.80.
